(19) United States
(12) Patent Application Publication
(10) Pub. No.: US 2006/0147698 A1
(43) Pub. Date: Jul. 6, 2006

(54) Garments preventing transmission of human body odor

(75) Inventors: Todd R. Carroll, Guntersville, AL (US); John D. Langley, Guntersville, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Kappler, Inc.

(21) Appl. No.: 11/363,125

(22) Filed: Feb. 27, 2006

Related U.S. Application Data
(63) Continuation of application No. 10/457,636, filed on Jun. 9, 2003, now abandoned.
(60) Provisional application No. 60/388,205, filed on Jun. 13, 2002.

(51) Int. Cl. B32B 3/00

(52) U.S. Cl. 428/316.6; 428/317.9

(57) ABSTRACT

The invention relates to a garment that protects against liquid and/or airborne contaminants and prevents transmission of human body odor. The garment includes a moisture vapor permeable, chemical and water impermeable microporous membrane arranged to form a barrier to chemical and particulate penetration and permeation through the garment. The membrane comprises a thermoplastic polymeric resin material and an activated carbon filler material distributed throughout the membrane and functioning both as a mechanical pore-forming agent for rendering the membrane microporous, and also as an adsorbent to render the membrane odor adsorptive.

### CROSS-REFERENCE TO RELATED APPLICATIONS

This application is a continuation of application Ser. No. 10/457,636 filed Jun. 9, 2003, now abandoned, which claims the benefit of U.S. Provisional Application No. 60/388,205, filed Jun. 13, 2002.

### FIELD OF INVENTION

This invention relates generally to garments, and more particularly to garments that protect against liquid and/or airborne contaminants and prevent transmission of human body odor.

### BACKGROUND OF THE INVENTION

Numerous approaches have been undertaken to develop clothing with protective barriers and composites that offer resistance to defined hazards while still offering the wearer a certain degree of comfort. High degrees of chemical resistance to a wide array of chemical hazards can be achieved using barrier materials in the form of air-impermeable continuous films and composites. However, protective clothing made of such barrier materials is uncomfortable, since the barrier material totally blocks the body's natural heat regulating ability. The expanded use of chemical protective clothing has pushed garment designers to explore alternative approaches to balancing barrier and comfort.

One approach to producing “breathable” chemical barriers has been described in von Blucher et al. U.S. Pat. No. 4,677,019. This approach, as well as numerous other variants, combines traditional textiles, nonwovens, foams, etc., with activated carbon in multi-layered laminates. Activated carbon is widely used as a sorptive media for the removal of impurities and/or gaseous species present in low concentration in liquid, air, and gas streams. Activated carbon is characterized by having high specific surface area (e.g., 300-2500 square meters per gram) consisting of macropores (i.e., pores with diameters greater than 500 angstroms), mesopores (i.e., pores of diameters 20-500 angstroms), and micropores (i.e., pores of a diameter less than 20 angstroms).

Activated carbon had been adapted for garment textile usage in various configurations such as described, for example, by Simpson U.S. Pat. No. 4,726,978, Goldberg U.S. Pat. No. 4,945,392, Katz U.S. Pat. No. 5,162,398, Sesslemann U.S. Pat. No. 5,383,236, Stelzmuller et al. U.S. Pat. No. 5,731,065, Smolik U.S. Pat. No. 5,769,992, and Conkle et al. U.S. Statutory Invention Registration No. H823.

The major advantage of activated carbon is its affinity for a wide range of chemical species. Its greatest disadvantages are ease of saturation to liquid exposure and durability of the adhered carbon. To avoid these limitations, manufacturers typically combine the activated carbon layer with an abrasion-resistant, liquid-repellent outer layer and an additional abrasion resistant inner layer. See Langston U.S. Pat. No. 5,112,666 and Collier et al. U.S. Pat. No. 5,453,314. The liquid-repellant finishes are typically surface treatments of silicones or Teflon® which provide run-off type performance but can still become saturated during heavy exposure to liquid challenges and can be easily overcome under pressure (i.e., hydrostatic pressure) such as can occur in the crutch of the arm and other high flex areas of a garment.

Several approaches have been made to develop strategies to avoid saturating the adsorptive media contained in these products. Simpson U.S. Pat. No. 4,726,978, Nomi U.S. Pat. No. 5,190,806 and Kelly U.S. Pat. No. 5,273,814, as well as others, have combined various porous, microporous, and monolithic layers with sorptive or detoxifying media in multi-layer composites. While functional, these complex structures are expensive, difficult to manufacture, and exhibit delicate field performance due to abrasion and adhesion issues of the sorptive media. Air-permeable outer layers are obviously preferred in garment applications since they will maximize wearer comfort. Microporous and monolithic layers offer no measurable airflow and thus must exhibit high rates of moisture vapor transmission to be usable as garment materials. A major deficiency in the air permeable approach is that these composites are limited to vapor and airborne challenges. The air-impermeable approaches have typically relied on monolithic films and coatings of polyurethane and polyester, or microporous films of sintered polytetrafluoroethylene (PTFE).

Microporous films comprised of polyolefins and polytetrafluoroethylenes are known in the art. Hoge U.S. Pat. No. 4,350,655, Sheth U.S. Pat. No. 4,777,073, Wu et al. U.S. Pat. No. 5,865,926, Soehngen et al. U.S. Pat. No. 4,257,997, Gillberg-LaForce U.S. Pat. No. 5,328,760, Nagou et al. U.S. Pat. No. 4,791,144, Jacoby U.S. Pat. No. 5,594,070, Gore U.S. Pat. No. 4,187,390, Weimer et al. U.S. Pat. No. 5,690,949, and others describe examples of coatings, films, membranes and composites that offer air impermeability, liquid resistance, and high degrees of moisture vapor transmission through various microporous structures. Processes for producing the micropores vary and include cold rolling, and stretching (mono-axially, biaxially, and incrementally) filled films. For stretched films, the mechanism for cavitation can include a solid particle (i.e., calcium carbonate) that will remain in the film after stretching or a soluble component (i.e., mineral oil) that can be extracted after stretching thus leaving the void.

Liquid-impermeability in microporous films is typically surface tension related and is controlled by the size and size distribution of the pores. The interconnection of the pores is the mechanism by which moisture vapor is transported through the otherwise air-impermeable films. By themselves, these membranes are best suited for liquid and particulate challenges and are otherwise penetrated by vapor challenges as they are by water vapor molecules.

Additional attempts have been made to improve the moisture vapor transmission capacity of monolithic or permselective films by incorporating various fillers that ideally disperse moisture via molecular diffusion through the adsorptive filler material such as described by Sikdar et al. U.S. Pat. No. 6,117,328. Moisture transport through these type films is limited by the fact that the filler material particles must be in direct contact with each other to provide a pathway for movement of the moisture. The chemical adsorption capacity of the filler material is further limited by the fact that its entire surface which would otherwise be available for adsorption is encased in the base resin of the permselective film.

Permselective films such as those described by Nakao et al. U.S. Pat. No. 4,909,810, Baker et al. U.S. Pat. No. 4,943,475, Athayde et al. U.S. Pat. No. 5,024,594, Baurmeister U.S. Pat. No. 5,743,775, Blume et al. U.S. Pat. No. 5,085,776, and others are using ultra-thin films in various composites in protective clothing, as well as gas and liquid separation applications. With chemical diffusion based on Fick's Law and diffusion and solubility parameters, these thin films are designed to preferentially allow the transport of one or more chemical species through the film. Those permselective films that are best suited for garment applications such as described by Baurmeister are based on cellulosic resins to allow the transport of moisture, but are unfortunately degraded by a wide range of common industrial chemicals which limits their applicability.

### SUMMARY OF THE INVENTION

The present invention addresses the above-mentioned deficiencies in sorptive fabrics, composites, and microporous films by disclosing a novel approach of combining the sorptive characteristics of activated carbon with the barrier properties of a microporous membrane, which translates to a simplified, high performance membrane, or composite that exhibits multiple attributes. The resultant membrane exhibits breathability via moisture vapor transmission, water and blood repellency, particulate penetration resistance, windproofness, odor adsorption and resistance to chemical penetration and permeation.

The present invention provides a garment that protects against liquid and/or airborne contaminants and prevents transmission of human body odor. The garment includes a flexible supporting substrate and a moisture vapor permeable, chemical and water impermeable microporous membrane arranged to form a barrier to chemical and particulate penetration and permeation through the garment. The membrane comprises a thermoplastic polymeric resin material and an activated carbon filler material distributed throughout the membrane and functioning both as a mechanical pore-forming agent for rendering the membrane microporous, and also as an adsorbent to render the membrane odor adsorptive.

In one specific embodiment, the garment comprises a multi-layer microporous composite sheet material having an outer surface and an inner surface. The multi-layer composite sheet material includes first and second moisture vapor permeable, chemical and water impermeable microporous membrane layers. The first membrane layer comprises a thermoplastic polymeric resin material and a filler material, wherein the filler material includes particles of calcium carbonate functioning as a mechanical pore forming agent for rendering the membrane microporous. The second membrane layer is arranged to form a barrier to chemical and particulate penetration and permeation through the garment. The second membrane layer comprises a thermoplastic polymeric resin material and a filler material, wherein the filler material includes particles of activated carbon which functions not only as a mechanical pore-forming agent for rendering the membrane microporous, but also as an adsorbent and renders the membrane odor adsorptive, resistant to chemical penetration and permeation, water and blood repellent, impermeable to air and liquids, and permeable to moisture vapor.

Performance characteristics in addition to those described above can be engineered into the membrane in several ways. Properties such as flame resistance, anti-static characteristics, thermal degradation resistance, UV resistance, degradability/compositibility, and other properties can be achieved through various custom and commercially available additive packages. For example, in addition to the activated carbon, there can also be dispersed throughout the membrane at least one additive selected from the group consisting of flame retardants, anti-static additives, anti-microbial additives, antioxidants, stabilizers, UV absorbers, and enzyme additives. Morrison U.S. Pat. No. 4,343,853, for example, describes various additives that can be incorporated into the membranes of the present invention to instill fungicidal and antibacterial characteristics, examples of which include nitrophenyl acetate, phenylhydrazine, polybrominated salicylanilides, chlorhexidine, domaphen bromide, cetylpyridinium chloride, benzethonium chloride, 2,2′-thiobisthiobis (4,6-dichloro)phenol, 2,2′-methelenebis(3,4,6′-trichloro)phenol, 2,4,4′-trichloro-2′-hydroxydiphenyl ether, and or other similar anti-microbial agents of which Microban® is a commercially available example. Weimer et al. U.S. Pat. No. 5,690,949 describe the use of fluorochemical additives as a method of improving the repellency characteristics of microporous films, preferable are fluorochemical oxazoidalinone compounds and flurochemical amino-alcohol compounds, and amorphous fluoropolymer of which Teflon® is a commercial example.

The present invention can be embodied as an adsorbent microporous free film or membrane, or as a composite containing the microporous adsorbent film or membrane combined with one or more additional microporous membranes and/or layers of fabric, scrim, or supporting media. The free film/membrane or the composite, can be used as a protective clothing item or liner, glove or liner, or outdoor sports apparel (i.e., hunting apparel, etc.), or other product applications requiring breathability, chemical and/or particulate resistance, and/or odor control.

### BRIEF DESCRIPTION OF THE DRAWING

Having thus described the invention in general terms, reference will now be made to the accompanying drawings, which are not necessarily drawn to scale, and wherein:

FIG. 1 is a schematic perspective view showing an unsupported free film membrane according to the present invention; and

FIGS. 2 to 6 are fragmentary perspective views showing composites according to several embodiments the present invention.

### DETAILED DESCRIPTION OF ILLUSTRATIVE EMBODIMENTS

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Microporous membranes in accordance with the present invention are produced from a thermoplastic polymeric resin material that is capable of being heated to a molten or flowable state and extruded in the form of a substantially continuous film. Suitable polymeric resin materials may be selected from the group consisting of polyolefins, polyolefin copolymers, polyesters, polyamides, polyvinyl alcohol, polycaprolactone, starch polymers, and blends of these materials. Particularly preferred polyolefin compositions include polypropylene, copolymers of propylene with ethylenically unsaturated monomers such as ethylene, high-density polyethylene, medium density polyethylene, and linear low density polyethylene.

The thermoplastic polymer resin material is blended with an activated carbon filler material. The amount of filler material present in the blend may be varied, depending upon the degree of porosity desired in the membrane. Preferably, however, the filler constitutes at least 5% by weight, and for some applications preferably from 40 to 90 weight percent of the blend. The filler and the resin material are blended together to form a homogeneous mixture, either in a preliminary compounding step or directly in a suitable mixing extruder. The activated carbon filler material can be used as the sole filler material in the resin, or in certain applications it may be desirable to blend additional filler materials as mechanical pore-forming agents with the activated carbon filler material. Examples of additional organic and/or inorganic mechanical pore-forming agent include zeolites, clay, calcium carbonate, barium sulfate, magnesium carbonate, magnesium sulfate, alkaline earth metals, baking soda, activated alumina, silica, calcium oxide, soda lime, titanium dioxide, aluminum hydroxide, ferrous hydroxides, diatomaceous earths, borax, acetyl salicylic acid, molecular sieves, ion exchange resins, talc, kaolin, silica, magnesium carbonate, barium carbonate, calcium sulfate, zinc oxide, calcium oxide, mica, glass, wood pulp, and pulp powder, and mixtures of the foregoing.

In addition, other additives can be incorporated into the membrane. For example, a starch additive can be dispersed throughout the membrane to promote degradation of the membrane when exposed to sunlight or other environmental influences. Other additives that can be blended with the polymer and activated carbon filler include flame retardants, anti-static additives, anti-microbial additives, antioxidants, stabilizers, UC absorbers, and enzymes.

The term “activated carbon” as used herein is a generic term describing a family of carbonaceous adsorbents with a highly crystalline form and extensively developed internal pore structure. A carbon substance is subjected to a controlled oxidation process, called “activation”, to develop its porous structure. The pores obtained offer a vast surface area capable of attracting an extensive number of molecules in liquid or gaseous phase through adsorption. The highly porous activated carbon may typically have surface areas of from about 300-2,500 square meters per gram. The greater the surface area, the higher the number of adsorptive sites available. These so-called active, or activated, carbons are widely used to adsorb various substances from gases or liquids. Various methods are used to determine the activity level of activated carbon. The Iodine number provides a measurement of the porosity of an activated carbon by adsorption of iodine from solution. Standard test method ASTM D4607 can be used for measuring Iodine Number. Preferably, the activated carbon used in the present invention should have an Iodine Number of at least 900 mg/g. Carbon tetrachloride activity provides a measurement of the porosity of an activated carbon by the adsorption of saturated carbon tetrachloride vapor. The carbon tetrachloride activity on a weight basis can be determined using the ASTM standard test method D3467. Activated carbons for use in the present invention preferably have a carbon tetrachloride activity of 60% or greater. Other test methods such as the butane test of ASTM method D5228 have also been devised for measuring the activity of activated carbon. The adsorption capacity of membranes in accordance with the present invention can be measured by adapting the industry standard tests, such as the carbon tetrachloride activity test of ASTM D3467, for a membrane material.

Activated carbons preferred for use in the present invention have a mean particle diameter less than 15 microns, more preferably less than 5 microns, and most desirably less than 1 micron (submicron). The mean particle diameter can be measured directly using laser measurement techniques. The activated carbon filler material can be treated with conventional surface modifiers to minimize agglomeration, improve dispersion and to facilitate obtaining high loading of the filler in the polymer material. For example stearates, such as calcium stearate, are conventionally used for this purpose.

The adsorbent microporous membrane of the present invention can take the form of an unsupported or “free” film, or the membrane can be combined with one or more other layers to form a microporous composite. The microporous membrane or composite can be manufactured in accordance with any of a number of manufacturing processes known in the art for producing microporous films and composites, such as those described in the below-mentioned U.S. patents, the disclosures of which are hereby incorporated by reference.

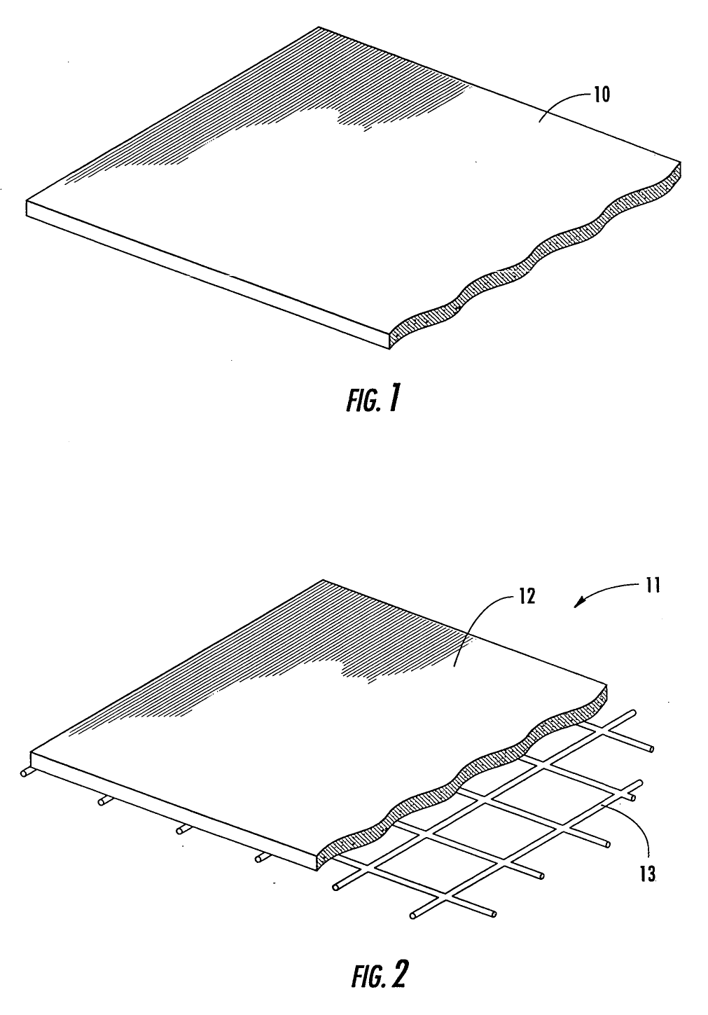

For example, an unsupported microporous “free” film membrane, such as that indicated by the reference number 10 in FIG. 1, can be produced generally in accordance with the teachings of Jacoby U.S. Pat. No. 5,594,070 by extruding a thermoplastic polymer composition containing activated carbon filler material and a beta-spherulite nucleating agent from a slot die to form a film, allowing the extruded continuous film to cool and solidify, subjecting the film to an extracting step to extract beta-spherulites, and subsequently stretching the thus formed film uniaxially or biaxially, thereby producing a film having microscopic pores throughout. The microscopic pores impart breathability to the film. The activated charcoal filler remains present in the film in the vicinity of the microscopic pores and thus imparts adsorbent properties to the microporous film membrane. Suitable adsorbent microporous membranes or films can also be produced without the extraction step. For example, following the teachings of the Hoge U.S. Pat. No. 4,350,655, a thermoplastic polymer composition blended with activated carbon in finely divided particulate form can be extruded from a slot die to form a film, and can be subsequently stretched, with or without embossing, to form adsorbent microporous film membrane. Similarly, a process similar to that described in Sheth U.S. Pat. No. 4,777,073 can be utilized to form adsorbent microporous film membrane from a blend of polypropylene or polyethylene and activated carbon. In this process, a continuous film is extruded from a slot die and his subsequently embossed with a pattern to embossing roller. The embossed film his subsequently cold stretched, imparting microporosity to the film.

Unsupported or “free” films produced by any of the above noted processes can be used alone, or they can be combined with additional layers or supporting substrates. For example, a microporous film can be laminated to a nonwoven, knitted, woven or scrim substrate either with an adhesive or by direct fusion of the thermoplastic film membrane, such as for example by thermal point bonds. FIG. 2 illustrates a composite material 11 in which an adsorbent microporous membrane 12 is laminated to a flexible scrim reinforcing substrate 13.

In yet another approach, a microporous adsorbent membrane material can be produced generally in accordance with the teachings of Weimer et al. U.S. Pat. No. 5,690,949. In this process the thermoplastic polymer material is blended with a mineral oil in addition to the activated carbon filler. Upon cooling of the thermoplastic polymer composition, a phase separation occurs between the polymer compound and the processing oil.

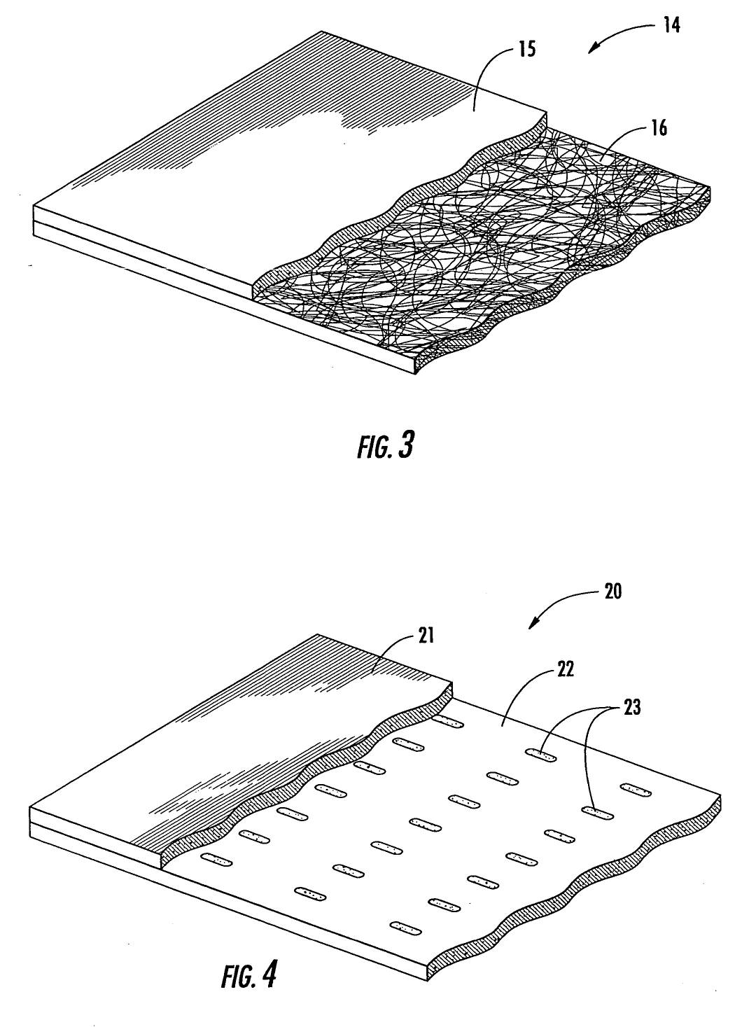

In still another embodiment, illustrated in FIG. 3, an adsorbent microporous membrane composite material 14 can be produced by extrusion coating a film or layer 15 of a microporous formable composition containing a thermoplastic polymer and activated carbon filler onto a nonwoven fabric reinforcing substrate material 16, to form a continuous film on the reinforcing substrate. The film/nonwoven substrate composite 14 is subsequently stretched to render the composite microporous. A process similar to that described in Wu et al. U.S. Pat. No. 5,865,926 can be suitably employed.

FIG. 4 illustrates a multi-layer microporous composite material 20 that includes an outer microporous membrane layer 21 formed from a stretched calcium carbonate-filled polymer film laminated to an underlying adsorbent microporous membrane layer 22 formed from a stretched activated carbon-filled polymer film 22 and adhered together by dots of an adhesive 23 applied in a open spaced pattern.

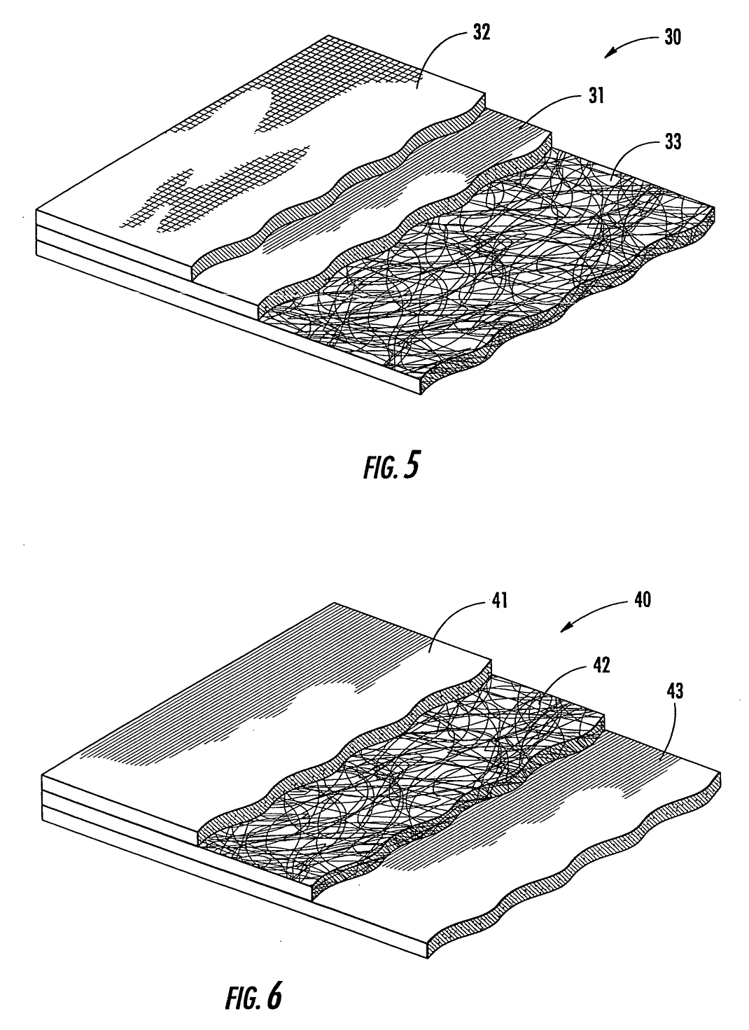

FIG. 5 illustrates a tri-laminate microporous composite material 30 that includes a microporous membrane inner layer 31 containing thermoplastic polymer and activated carbon filler, with an outer layer 32 laminated to the membrane by an adhesive (not shown) such as a hot melt adhesive or a polyurethane adhesive. A rear fabric layer 33 formed of a spunbond nonwoven fabric is laminated to the rear surface of the inner membrane layer 31.

FIG. 6 illustrates a tri-laminate microporous composite material 40 that includes an outer microporous membrane layer 41 formed from a stretched calcium carbonate-filled polymer film laminated to an underlying spunbond nonwoven fabric reinforcing layer 42, which in turn, is laminated to an adsorbent microporous membrane layer 43 formed from a stretched activated carbon-filled polymer film. The layers are adhered together by adhesive (not shown) applied by spraying.

### EXAMPLES

The following embodiments of the disclosed invention demonstrate the potential breadth and significance of the present invention. Inclusion of these embodiments in no way serves to limit the potential breath and applicability of the present invention to other configurations and or uses.

### Example 1

A microporous, activated carbon filled membrane is formed generally according to the process as described by Jacoby U.S. Pat. No. 5,594,070 wherein a film of thickness greater than 0.005 mm and less than 2 mm, and more preferably 0.01 mm to 1.0 mm is formed from the following composition on a cast-film extrusion line at a temperature between 180° C. and 275° C. The composition includes 100 parts by weight of polymeric resin, 40-90 parts by weight of which is an ethylene-propylene block copolymer having an ethylene content of 30-45% (available from Himont), 5-40 parts by weight of which is polypropylene homopolymer with a melt flow rate of 1-30 dg/min per ASTM D1238 (available from Amoco Chemical Company), 1-10 parts by weight of which is a low molecular weight polypropylene having a melt viscosity of 70-500 poise (available from Polyvisions Inc.). The composition additionally includes 0.5-10 ppm of red quinacridone dye beta-spherulite nucleating agent and 5-30 parts by weight of activated carbon having a mean particle diameter between 0.1 μm and 10-μm. The cast film is subsequently reheated to between 35° C. and 140° C., and stretched either monoaxially or biaxially on a tenter frame at a stretch ratio of 1.5 to 10 to induce pore formation. The activated carbon filled membrane of this example can be formed and wound up on a roll for subsequent mono- or biaxial stretching, or can be stretched in-line during the film casting process.

The microporous, activated carbon filled membrane made according to this example can be further laminated to additional layers of similar or different microporous membranes or coatings, and/or to one or more layers of woven, nonwoven, or foamed fabrics. Examples of such fabrics include spunbonded fabrics, needled fabrics, hydro-entangled fabrics, powder-bonded fabrics, flashspun fabrics, carded webs, meltblown fabrics, self-bonded fabrics, cross-laminated fibrillated film fabrics, scrims, woven fabrics, knitted fabrics, as well as other woven and nonwoven fabrics. These fabrics can be constructed of one type of fibers or blends of different fibers, the fibers themselves of which can be bicomponent fibers. If desired these fabrics can be fabricated to have adsorbtive properties, such as by using adsorbent coatings, impregnants, or adsorbent fibers. These composites can be laminated together in various configurations of microporous membranes and fabrics to achieve the desired end performance characteristics according to various common laminating techniques including adhesive, extrusion, thermal, flame, solvent, and ultrasonics.

Membranes and composites made according to this invention can be employed in a wide range of applications requiring moisture vapor transmission, resistance to particulate penetration, resistance to chemical penetration and permeation, as well as characteristics of odor control. Anticipated applications include protective garments for protection against liquid and/or airborne contaminants, garments for preventing transmission of human body odor, such as hunting garments, garment inserts, gloves, glove inserts, shoe inserts, seam tape for taping the seams of protective garments, packaging materials, personal hygiene products, including infant diapers and adult incontinence products, feminine hygiene products, surgical gowns, drapes, and related items, building construction items including housewrap and roofing underlayment, outdoor covers, filters, liquid and gas separation membranes, battery separators, etc.

### Example 2

A microporous, activated carbon filled membrane is formed according to Example 1 with the addition of 100-2000 ppm of an antimicrobial additive such as 2,4,4′-trichloro-2′-hydoxydiphenyl ether (example of which is available as Microban® from Clinitex Corp.).

### Example 3

Similar examples of microporous, activated carbon filled membranes can be formed generally according to the process described by Weimer et al. U.S. Pat. No. 5,690,949 with the addition of activated carbon. The polymeric composition includes a processing compound such as a hydrocarbon liquid (i.e., mineral oil) that will dissolve in the polymer resin matrix and phase separate upon cooling and a fluorochemical additive to improve water and oil repellency. Here, the stretched film is annealed at between 100° C. and 150° C. after stretching. In this case, the activated carbon is suspended in the hydrocarbon liquid processing agent during compounding, mixing, and extrusion (i.e., either cast or blown film) and remains in the micropores after stretching thus imparting adsorptive characteristics to the final film or membrane.

### Example 4

A microporous, activated carbon filled membrane is formed generally according to the process described by Wu et al. U.S. Pat. No. 5,865,926 wherein a film of thickness greater than 0.25 mils and less than 10.0 mils, and more preferably 0.25 mils to 2.0 mils, is formed from a microporous formable, activated carbon filled resin that has been extrusion coated onto a 0.25 oz/yd² to 5 oz/yd² spunbonded polypropylene fabric (example of which is available from BBA Nonwovens) and is subsequently stretched by passing the composite through a series of intermeshing rollers thus causing cavitation around the activated carbon and inducing breathability via a system of interconnected micropores. The microporous formable polymeric resin composition for this example is comprised of 17-82% by weight of a polyolefin such as low density polyethylene, linear low density polyethylene, high density polyethylene, polypropylene, and copolymers such as ethylene vinyl acetate (EVA), ethylene methylacrylate (EMA) and ethylene acrylic acid (EAA), or blends thereof, 17-67% by weight of activated carbon having a mean particle diameter between 0.5 μm and 8.0 μm and more preferably around 1 μm, and 1-67 weight percent of a liquid or waxy hydrocarbon polymer such as liquid polybutene, polybutadiene or hydrogenated liquid polybutadiene. The microporous formable composition is extruded on common extrusion equipment at a melt temperature between 400° F. and 500° F. with a nip pressure between 10 and 80 psi. Alternatively a vacuum roller can be used in place of the nip roller to promote lamination of the microporous formable resin to the nonwoven material. Incremental stretching is accomplished by preheating the microporous formable, activated carbon filled web to between 70° F. and 90° F. and passing it through intermeshing rollers that induce an incremental degree of stretch. Stretching can be either diagonally which induces both machine and transverse stretch, or alternatively, the web can be stretched by a set of transverse intermeshing rollers, or a set of machine direction intermeshing rollers or a combination of such. The preferred intermeshing engagement is 0.06 inch to 0.12 inch to induce sufficient microporosity. Unlike the uniform microporosity of Example 1, this technique induces defined incremental microporosity thus leaving a portion of the composite non-porous, which can have unique application especially in the area of permselective membranes.

### Example 5

The microporous formable polymeric resin composition of Example 4 is extrusion cast as a free film. Subsequently, the free film is incrementally stretched as described in Example 4.

### Example 6

A microporous activated carbon filled free film is formed according to Example 5. The unstretched membrane is laminated to a 0.25 oz/yd² to 5 oz/yd² spunbonded polypropylene fabric (an example of which is available from BBA Nonwovens) using a hot melt, aqueous, or solid based adhesive system. This composite is subsequently incrementally stretched as described in Example 4.

### Example 7

A microporous, activated carbon filled membrane is formed according to the cold draw process as described by Hoge U.S. Pat. No. 4,350,655 wherein a film of thickness greater than about 0.25 mils and less than about 10.0 mils, and more preferably about 5.0 mils, is formed from a highly filled thermoplastic composition that is stretched via the cold draw process. The thermoplastic composition of the membrane contains between 30% and 50% by weight of one or more polymeric resins including high density polyethylene, polyethylene, low density polyethylene, linear low density polyethylene, polypropylene, polyamide, polyester, or blends thereof, and 50% to 70% by weight of activated carbon having a mean particle diameter between 0.5 μm and 10 μm and more preferably between 1 μm and 5 μm. The activated carbon filled resin composition is extruded on common extrusion equipment at a temperature between 180° C. and 400° C. and then rapidly cooled to 10° C. to 70° C. to minimize any stretching of the hot web. The chilled web is then stretched monoaxially or biaxially using grooved rollers as common in the art to induce the desired level of microporosity. Stretching rates of <300 cm/sec inducing stretch ratios of between 2× and 5× are preferred. Variations in resin blends and stretch ratios can and do affect the final performance of the film. In a variation of this example, the activated carbon filled composition is melt embossed during the casting process and prior to stretching to induce other characteristics to the final structure.

It should be evident that the present invention is applicable to other microporous film forming processes, its novelty being to induce “active” adsorptive properties to otherwise “passive” microporous films and composites. It should be further noted that multiple layers of microporous films could be combined by themselves or with various fabrics according to known laminating techniques (i.e., thermal, adhesive, extrusion, ultrasonic, etc.) to produce a variety of performance characteristics. These composites can include both traditional filled microporous films and activated carbon filled microporous films and coatings. The activated carbon filled films of which can also include other organic and inorganic mechanical pore forming agents and other additives.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A garment that protects against liquid and/or airborne contaminants and prevents transmission of human body odor, said garment including a flexible supporting substrate and a moisture vapor permeable, chemical and water impermeable microporous membrane arranged to form a barrier to chemical and particulate penetration and permeation through the garment, said membrane comprising a thermoplastic polymeric resin material and an activated carbon filler material distributed throughout the membrane and functioning both as a mechanical pore-forming agent for rendering the membrane microporous, and also as an adsorbent to render the membrane odor adsorptive.

2. The garment of claim 1, wherein the activated carbon filler material has a mean particle diameter of less than 15 microns.

3. The garment of claim 1, wherein the membrane is an unsupported film.

4. The garment of claim 1, wherein the membrane is a coating supported by said flexible supporting substrate.

5. The garment of claim 4, wherein the flexible supporting substrate is a nonwoven fabric.

6. The garment of claim 1, including an additional nonwoven fabric layer that has adsorptive properties combined with said membrane.

7. The garment of claim 1, including one or more additional microporous membrane layers combined with said membrane.

8. The garment of claim 7, wherein at least one of said additional microporous membrane layers comprises a polymeric resin material and a mechanical pore-forming agent selected from the group consisting of zeolites, clay, calcium carbonate, barium sulfate, magnesium carbonate, magnesium sulfate, alkaline earth metals, baking soda, activated alumina, silica, calcium oxide, soda lime, titanium dioxide, aluminum hydroxide, ferrous hydroxides, diatomaceous earths, borax, acetyl salicylic acid, molecular sieves, ion exchange resins, talc, kaolin, silica, magnesium carbonate, barium carbonate, calcium sulfate, zinc oxide, calcium oxide, mica, glass, wood pulp, and pulp powder.

9. The garment of claim 1, wherein the membrane has been treated with a hydrophobic agent.

10. The garment of claim 1, in which there is also dispersed throughout the membrane at least one additive selected from the group consisting of flame retardants, anti-static additives, anti-microbial additives, antioxidants, stabilizers, UV absorbers, and enzyme additives.

11. The garment of claim 1, wherein said supporting substrate is a nonwoven fabric layer, and wherein the membrane layers is formed by extrusion coating a layer of a microporous formable composition containing said thermoplastic resin material and a filler material onto the nonwoven fabric layer to form a continuous film on the nonwoven fabric alyer, and subsequently stretching the film/nonwoven fabric composite to render the composite microporous.

12. A garment that protects against liquid and/or airborne contaminants and prevents transmission of human body odor, said garment comprising a microporous composite sheet material having an outer surface and an inner surface and comprising a first moisture vapor permeable, chemical and water impermeable microporous membrane layer arranged to form a barrier to chemical and particulate penetration and permeation through the garment, said membrane comprising a thermoplastic polymeric resin material and a filler material functioning as a mechanical pore-forming agent for rendering the membrane microporous, wherein the filler material includes particles of activated carbon having a mean particle diameter of less than 15 microns and forming at least 5 percent weight percent of the membrane, and the activated carbon functions not only as a mechanical pore-forming agent but also as an adsorbent and renders the membrane odor adsorptive, resistant to chemical penetration and permeation, water and blood repellent, impermeable to air and liquids, and permeable to moisture vapor, and at least one reinforcing layer selected from the group consisting of woven fabrics, knitted fabrics, nonwoven fabrics, and scrims.

13. The garment of claim 12 also including a second microporous membrane layer comprising a polymeric resin material and a second mechanical pore forming agent that is different from said activated carbon filler material, said second microporous membrane layer being located closer to said outer surface than the first microporous membrane layer.

14. The garment of claim 12 wherein the at least one reinforcing layer comprises a spunbond nonwoven fabric reinforcing layer which is laminated to a surface of the said first microporous membrane layer.

15. A garment that protects against liquid and/or airborne contaminants and prevents transmission of human body odor, said garment comprising a multi-layer microporous composite sheet material having an outer surface and an inner surface, said multi-layer composite sheet material including a first moisture vapor permeable, chemical and water impermeable microporous membrane layer comprising a thermoplastic polymeric resin material and a filler material, wherein the filler material includes particles of calcium carbonate functioning as a mechanical pore forming agent for rendering the membrane microporous, and a second moisture vapor permeable, chemical and water impermeable microporous membrane layer arranged to form a barrier to chemical and particulate penetration and permeation through the garment, said second membrane layer comprising a thermoplastic polymeric resin material and a filler material, wherein the filler material includes particles of activated carbon which functions not only as a mechanical pore-forming agent for rendering the membrane microporous, but also as an adsorbent and renders the membrane odor adsorptive, resistant to chemical penetration and permeation, water and blood repellent, impermeable to air and liquids, and permeable to moisture vapor.

16. The garment of claim 15, wherein the multi-layer microporous composite sheet material includes at least one reinforcing layer selected from the group consisting of woven fabrics, knitted fabrics, nonwoven fabrics, and scrims.

17. The garment of claim 16, wherein the at least one reinforcing layer comprises a spunbond nonwoven fabric reinforcing layer which is located between said first microporous membrane layer and said second microporous membrane layer.

18. A garment that protects against liquid and/or airborne contaminants and prevents transmission of human body odor, said garment comprising a multi-layer microporous composite sheet material having an outer surface and an inner surface, said multi-layer composite sheet material including a first moisture vapor permeable, chemical and water impermeable microporous membrane layer comprising a thermoplastic polymeric resin material and a filler material, wherein the filler material includes particles of calcium carbonate functioning as a mechanical pore forming agent for rendering the membrane microporous, a second moisture vapor permeable, chemical and water impermeable microporous membrane layer arranged to form a barrier to chemical and particulate penetration and permeation through the garment, said second membrane layer comprising a thermoplastic polymeric resin material and a filler material, wherein the filler material includes particles of activated carbon which functions not only as a mechanical pore-forming agent for rendering the membrane microporous, but also as an adsorbent and renders the membrane odor adsorptive, resistant to chemical penetration and permeation, water and blood repellent, impermeable to air and liquids, and permeable to moisture vapor, and at least one reinforcing layer selected from the group consisting of woven fabrics, knitted fabrics, nonwoven fabrics, and scrims.

19. The garment of claim 18, wherein said at least one reinforcing layer is a nonwoven fabric layer, and wherein one of said first and second membrane layers is formed by extrusion coating a layer of a microporous formable composition containing said thermoplastic resin material and a filler material onto the nonwoven fabric layer to form a continuous film on the nonwoven fabric alyer, and subsequently stretching the film/nonwoven fabric composite to render the composite microporous.
